(19) United States
(12) Patent Application Publication
(10) Pub. No.: US 2016/0047257 A1
(43) Pub. Date: Feb. 18, 2016

(54) MOUNTING ARRANGEMENT FOR AEROFOIL BODY

(71) Applicant: ROLLS-ROYCE PLC, London (GB)

(72) Inventors: Steven Aleksy RADOMSKI, Nottingham (GB); Matthew Paul JEVONS, Diedorf (DE)

(21) Appl. No.: 14/817,784

(22) Filed: Aug. 4, 2015

(30) Foreign Application Priority Data
Aug. 18, 2014 (GB) 1414587.4

(51) Int. Cl. F01D 9/04

(52) U.S. Cl. CPC F01D 9/042; F01D 9/041; F05D 2220/32; F05D 2240/125; F05D 2300/2102; F05D 2300/603; F05D 2300/224

(57) ABSTRACT

The present disclosure provides an aerofoil body comprising a root portion and a tip portion, each having a pressure surface and a suction surface. The pressure surface and suction surface of the root and/or tip portion each comprise a respective ridge portion. Each ridge portion has an inclined first face and an oppositely inclined second face. Each ridge portion may be, for example, a triangular or semi-circular prism.

### CROSS-REFERENCE TO RELATED APPLICATIONS

This application is based upon and claims the benefit of priority from British Patent Application Number 1414587.4 filed 18 Aug. 2014, the entire contents of which are incorporated by reference.

### BACKGROUND

1. Field of the Disclosure

The present disclosure relates to an aerofoil body such as a blade or guide vane for a gas turbine engine and a mounting arrangement for such an aerofoil body.

2. Description of the Related Art

With reference to FIG. 1, a ducted fan gas turbine engine is generally indicated at 10 and has a principal and rotational axis X-X. The engine comprises, in axial flow series, an air intake 11, a propulsive fan 12, an intermediate pressure compressor 13, a high-pressure compressor 14, combustion equipment 15, a high-pressure turbine 16, an intermediate pressure turbine 17, a low-pressure turbine 18 and a core engine exhaust nozzle 19. A nacelle 21 generally surrounds the engine 10 and defines the intake 11, a bypass duct 22 and a bypass exhaust nozzle 23.

During operation, air entering the intake 11 is accelerated by the fan 12 to produce two air flows: a first air flow A into the intermediate pressure compressor 13 and a second air flow B which passes through the bypass duct 22 to provide propulsive thrust. The intermediate pressure compressor 13 compresses the air flow A directed into it before delivering that air to the high pressure compressor 14 where further compression takes place.

The compressed air exhausted from the high-pressure compressor 14 is directed into the combustion equipment 15 where it is mixed with fuel and the mixture combusted. The resultant hot combustion products then expand through, and thereby drive the high, intermediate and low-pressure turbines 16, 17, 18 before being exhausted through the nozzle 19 to provide additional propulsive thrust. The high, intermediate and low-pressure turbines respectively drive the high and intermediate pressure compressors 14, 13 and the fan 12 by suitable interconnecting shafts.

Each of the high and intermediate compressors 14, 13 comprises a number of alternating series of circumferentially-spaced rotating blades and circumferentially-spaced static vanes. The rotating blades act to compress the air flow A whilst the static vanes act to direct the compressed air onto the next series of rotating blades. Outlet guide vanes (OGVs) at the exit of the high pressure compressor 14 act to optimise (straighten) the direction of the air flow A into the combustion equipment 15.

The OGVs are mounted between an inner ring and an outer ring, the vanes and rings typically being formed of homogenous metallic or reinforced metallic/non-metallic material. OGV assemblies formed of reinforced plastic material are preferable as they are lighter than metallic OGV assemblies. In OGV assemblies formed of reinforced plastics material, the vanes may affixed to the inner and outer rings using either dove-tail joints or “L-angle” joints. In both cases, the vanes are formed with the reinforcing fibres aligned from the root to the tip of the vane. When a dovetail joint is used to affix the vane to the rings, the reinforcing fibres are splayed towards the root and/or tip of the vane and wedging fibres are introduced between the splayed fibres to form the necessary wedge-shaped root/tip portion. When an L-angle joint is used to affix the vane to rings, the reinforcing fibres are angled through 90 degrees.

Both dovetail joints and L-angle joints have their weaknesses. Dovetail joints, whilst good under tension, are poor under compression, shear and bending. L-angle joints, whilst good under shear loading, are poor under direct loading and bending. To accommodate these weaknesses, in both joint styles, the OGV needs to be significantly thickened which compromises the aerodynamic efficiency.

There is the need for an improved mounting arrangement between a reinforced plastic OGV and the supporting inner and outer rings which firmly affixes the vane to the rings and which can accommodate direct, shear and bending forces without requiring a thickening of the vane.

### OBJECTS AND SUMMARY

In a first aspect, the present disclosure provides an aerofoil body comprising a root portion and a tip portion, each having a pressure surface and a suction surface, wherein the pressure surface and suction surface of the root and/or tip portion each comprise a respective ridge portion, each ridge portion having an inclined first face and an oppositely inclined second face.

By providing a ridge portion having two, oppositely inclined faces on each side of the root/tip portion, reaction of tension, compression and bending loads applied to the aerofoil body is improved because the forces can be better transferred to the surrounding structures supporting the aerofoil body. Unlike an aerofoil body with a dovetail wedge (which only has one inclined surface on each of the pressure/suction surfaces and which can only react tensile forces adequately), reaction of compressive forces as well as shearing and bending forces is accommodated well. The compressive forces are reacted by the inclined faces opposite to those normally provided on a dovetail wedge and the reaction of shearing and bending forces are improved because there are two faces on each of the pressure/suctions surfaces for moment reaction.

Optional features of the disclosure will now be set out. These are applicable singly or in any combination with any aspect of the disclosure.

In some embodiments, the pressure surface and suction surface of both the root and tip portion each comprise a respective ridge portion, each ridge portion having a respective inclined first face and a respective oppositely inclined second face.

In some embodiments, the first and second faces of each ridge portion join one another at the apex of the respective ridge portion.

In some embodiments, the height of the ridge portion from the respective pressure/suction surface is between 10 and 50% of the spacing between the pressure and suction surfaces of the root/tip portion.

In some embodiments, the first and second faces of each ridge portion are oppositely and equally inclined.

In some embodiments, the first face and/or second face of each ridge portion is/are planar.

Where both the first and second faces are planar and join one another at the apex of the ridge portion, the ridge portion is shaped as a triangular prism. Since the ridge portions are provided on both the pressure and suction surfaces, the root/tip portion has a thickened portion formed of the opposing ridge portions, the thickened portion having a substantially diamond/kite-shaped cross-sectional profile (at right angles to the pressure/suction surfaces of the aerofoil body).

In some embodiments, the first face and/or second faces of each ridge portion is/are curved e.g. the first and/or second faces of each ridge portion is/are convex surfaces.

Where both the first and second faces are convex and join one another at the apex of the ridge portion, the ridge portion is shaped as a semi-circular prism. Since the ridge portions are provided on both the pressure and suction surfaces, the root/tip portion has a thickened portion formed of the opposing ridge portions, the thickened portion having a substantially circular cross-sectional profile (at right angles to the pressure/suction surfaces of the aerofoil body).

In some embodiments, the ridge portions are spaced from the end of the root/tip portion. This further improves the moment reaction for bending/shearing forces.

In some embodiments, the aerofoil body is a blade e.g. a blade for a fan, compressor or turbine in a gas turbine engine. In some embodiments, the aerofoil body is a vane e.g. a guide vane such as an outlet guide vane for a compressor in a gas turbine engine.

In some embodiments, the aerofoil body is formed of an organic matrix composite (OMC) (e.g. fibre reinforced plastic material) or a metal matrix composite (MMC).

The organic matrix may be a thermoplastic polymer matrix.

In some embodiments, the fibres e.g. glass, ceramic or carbon fibres in the reinforced plastic material used to manufacture the aerofoil body are substantially aligned in the aerofoil body from the root to tip portion and are splayed in the vicinity of the ridge portions with wedging plies inserted between the splayed fibres.

In a second aspect, the present disclosure provides a mounting arrangement for mounting an aerofoil body on an annular support, the mounting arrangement comprising:
an aerofoil body according to the first aspect, and
at least one mounting bracket,
   wherein the at least one mounting bracket has a central portion housing the ridge portions on the root or tip portion and a flange portion (for example two opposing flange portions) extending from the central portion at right angles to the central portion and for affixing to the annular support.

By providing a mounting bracket having a central portion housing the ridge portions and perpendicularly extending flange portions (which can be affixed e.g. bolted, onto the inner or outer annular supports), shearing loads on the aerofoil body can be transferred to the central portion of the mounting bracket through the oppositely inclined faces of the ridge portion and subsequently through 90 degrees to the flange portions without requiring a thickening of the aerofoil body.

The or each bracket may be said to have a wasted section that cooperates with the ridge portion of the tip or root. The central portion may be described as and/or may comprise such a wasted section.

In some embodiments, the mounting arrangement comprises two mounting brackets, one having a central portion housing the ridge portions on the root portion and one having a central portion housing the ridge portions on the tip portion.

The at least one mounting bracket may be affixed e.g. bolted to the radially outer surface of the radially inner annular support or the radially inner surface of the radially outer annular support. Fairings may be provided to cover the fixings to improve aerodynamic efficiency.

In some embodiments where the aerofoil body has ridge portions at only one of the root/tip portion, the mounting bracket may be affixed to the radially inner surface of the radially inner annular support or to the radially outer surface of the radially outer annular support with the aerofoil body extending through the radially inner/radially outer annular support. In this way, the fixings are kept out of the gas flow path.

In some embodiments, the mounting bracket(s) is/are formed of a sheet moulding compound (SMC) or an OMC e.g. from a glass, ceramic or carbon fibre-reinforced plastics material. In this case, the fibres may be aligned in the central portion and then deflect through 90 degrees to extend along the flange portions. The mounting bracket(s) may be cured or moulded around the root/tip portion of the aerofoil body. This obviates the need for bolting of the root/tip portion of the aerofoil body which, in turn, allows a reduction in the radial length of the aerofoil body (since bolting requires a certain spacing between the bolt and the radial end of the root/tip portion to ensure structural integrity of the root/tip portion).

The mounting bracket(s) may have web portions having an inclined surface extending from the central portion to the flange portions to reinforce the mounting bracket.

In a third aspect, the present disclosure provides a vane assembly comprising:
a mounting arrangement according to the second aspect having two mounting brackets, one having a central portion housing the ridge portions on the root portion and one having a central portion housing the ridge portions on the tip portion;
a radially inner annular support; and
a radially outer annular support,
   wherein the flange portions of the mounting bracket having a central portion housing the ridge portions on the root portion are affixed to the radially inner annular support and the flange portions of the mounting bracket having a central portion housing the ridge portions on the tip portion are affixed to the radially outer annular support.

The mounting brackets may be affixed e.g. bolted to the radially outer surface of the radially inner annular support and radially inner surface of the radially outer annular support. Fairings may be provided to cover the fixings to improve aerodynamic efficiency.

In some embodiments, the vane assembly comprises a plurality of circumferentially-spaced aerofoil assemblies each according to the second aspect.

In a fourth aspect, the present disclosure provides an axial compressor for a gas turbine engine having an aerofoil body according to the first aspect, a mounting arrangement according to the second aspect or a vane assembly according to the third aspect.

In a fifth aspect, the present disclosure provides a gas turbine engine having an aerofoil body according to the first aspect, a mounting arrangement according to the second aspect, a vane assembly according to the third aspect or an axial compressor according to the fourth aspect.

### BRIEF DESCRIPTION OF THE DRAWINGS

Embodiments of the disclosure will now be described by way of example with reference to the accompanying drawings in which:

FIG. 1 shows a ducted fan gas turbine engine;

FIG. 2 shows a first embodiment of an outlet guide vane assembly; and

FIG. 3 shows a second embodiment of an aerofoil body.

### DETAILED DESCRIPTION OF EMBODIMENTS

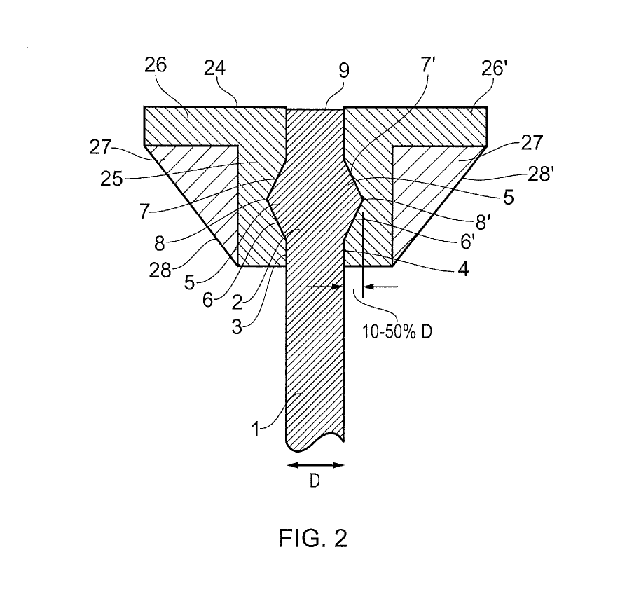

FIG. 2 shows an outlet guide vane assembly comprising an aerofoil body (vane) 1 comprising a root portion 2 and a tip portion (not shown).

The root portion 2 has a pressure surface 3 and a suction surface 4. Each surface comprises a ridge portion 5, 5′. Each ridge portion 5, 5′ comprises an inclined first face 6, 6′ and an oppositely and equally inclined second face 7, 7′.

The first and second faces 6, 6′, 7, 7′ are planar and join one another at the apex 8, 8′ of the ridge portion 5, 5′. Accordingly, each ridge portion 5, 5′ is shaped as a triangular prism. Since ridge portions 5, 5′ provided on both the pressure and suction surfaces 3, 4, the root portion 2 has a thickened portion formed of the opposing ridge portions 5, 5′, the thickened portion having a substantially diamond/kite-shaped cross-sectional profile (at right angles to the pressure/suction surfaces 3, 4 of the aerofoil body 1).

The height of the ridge portions 5, 5′ i.e. distance from the apex 8, 8′ to the respective pressure surface/suction surface 3, 4 is between 10 and 50% of the spacing D between the pressure and suction surfaces 3, 4 of the root portion 2.

The ridge portions 5, 5′are spaced from the end 9 of the root portion 2.

The aerofoil body (vane) 1 is formed of a fibre reinforced plastics material. The plastic matrix material may be a thermoplastic polymer. The fibres e.g. glass, ceramic or carbon fibres in the reinforced plastic material are substantially aligned in the aerofoil body 1 from the root portion 2 to tip portion and are splayed in the vicinity of the ridge portions 5, 5′ with wedging plies inserted between the splayed fibres. The fibres may be provided in the form of a non-crimped fabric.

A mounting bracket 24 formed of fibre-reinforced plastic is moulded around the root portion 2 and has a central portion 25 which surrounds the ridge portions 5. Two opposing flange portions 26, 26′ extend perpendicularly from the central portion 25. The fibres in fibre reinforced plastic are aligned in the central portion 25 (parallel to the fibres in the aerofoil body 1) and then deflect through 90 degrees to extend along the flange portions 26, 26′.

The mounting bracket 24 has web portions 27, 27′ each having an inclined surface 28, 28′ extending from the central portion 25 to the flange portions 26, 26′ to reinforce the mounting bracket 24.

The flange portions 26, 26′ are affixed e.g. bolted to a radially inner annular support (not shown). It should be noted that the radially annular support will support a series of circumferentially-spaced aerofoil bodies (vanes) identical to that shown in FIG. 2.

Although not shown, the tip portion of each aerofoil body 1 may have an identical structure to the root portion 2 and is retained within a respective second mounting bracket which is affixed to an outer annular support. Accordingly, FIG. 2 may alternatively show a tip portion, with the same reference numerals applying to both the root portion and the tip portion.

By providing ridge portions 5, 5′ having two, oppositely inclined faces 6, 6′, 7, 7′ on each side of the root/tip portions 2, reaction of tension, compression and bending loads applied to the aerofoil body 1 is improved because the forces can be better transferred (through the mounting bracket 24) to the annular supports supporting the aerofoil body 1. The mounting bracket 24 acts to transfer the loads through 90 degrees to the flange portions 26, 26′ without requiring a thickening of the aerofoil body 1.

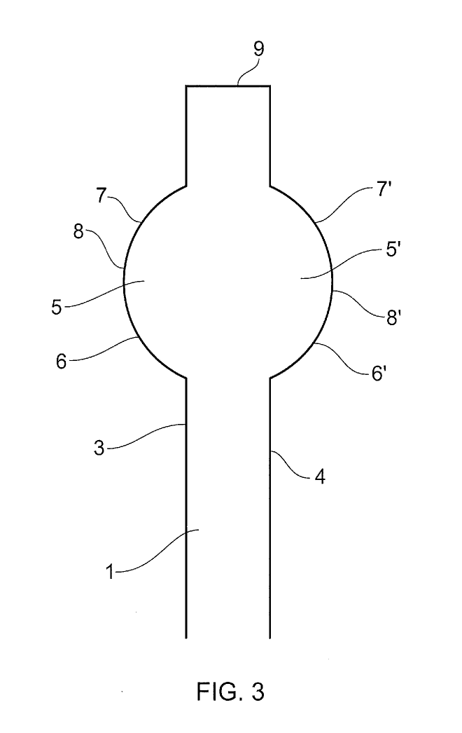

A second embodiment of an aerofoil body in shown in FIG. 3. In this embodiment, the first face and second faces 6, 6′, 7, 7′ of each ridge portion 5, 5′ are curved convex surfaces which meet at the apex 8, 8′ such that the ridge portions 5, 5′ are shaped as a semi-circular prism. Since ridge portions 5, 5′ are provided on both the pressure and suction surfaces 3, 4, the root portion 2 having a thickened portion formed of the opposing ridge portions 5, 5′, the thickened portion having a substantially circular cross-sectional profile (at right angles to the pressure/suction surfaces 3, 4 of the aerofoil body 1).

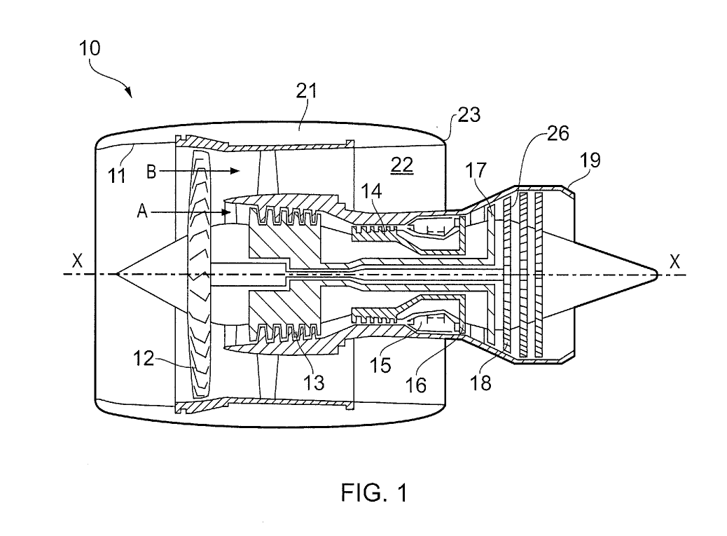

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention. The gas turbine engine shown in FIG. 1 may be provided with any of the arrangements described and/or claimed herein, and so may itself be in accordance with the invention.

All references referred to above are hereby incorporated by reference.

We claim:

1. A mounting arrangement for mounting an aerofoil body on an annular support, the mounting arrangement comprising:
an aerofoil body comprising a root portion and a tip portion, each having a pressure surface and a suction surface, wherein the pressure surface and suction surface of the root and/or tip portion each comprise a respective ridge portion, each ridge portion having an inclined first face and an oppositely inclined second face, and
at least one mounting bracket, wherein:
the at least one mounting bracket has a central portion housing the ridge portions on the root or tip portion and an opposing flange portion extending from the central portion at right angles to the central portion and for affixing to the annular support; and
the mounting bracket(s) is/are formed from a glass, ceramic or carbon fibre-reinforced plastics material and are cured or moulded around the root/tip portion of the aerofoil body.

2. A mounting arrangement according to claim 1, wherein the first and second faces of the ridge portion join one another at an apex of the ridge portion.

3. A mounting arrangement according to claim 1 wherein the first and second faces of the ride portion are oppositely and equally inclined.

4. A mounting arrangement according to claim 1, wherein the first face and/or second face of each ridge portion is/are planar.

5. A mounting arrangement according to claim 4, wherein the ridge portion is shaped as a triangular prism.

6. A mounting arrangement according to claim 1 wherein the first face and/or second faces of each ridge portion is/are curved.

7. A mounting arrangement according to claim 6 wherein the first and/or second faces of each ridge portion is/are convex surfaces.

8. A mounting arrangement according to claim 7 wherein the ridge portion is shaped as a semi-circular prism.

9. A mounting arrangement according to claim 1 wherein the pressure surface and suction surface of both the root and tip portion of the aerofoil body each comprise a respective ridge portion.

10. A mounting arrangement according to claim 1 wherein the aerofoil body is formed of a fibre-reinforced plastic material.

11. A mounting arrangement according to claim 1 wherein the aerofoil body is an outlet guide vane for a compressor in a gas turbine engine.

12. A mounting arrangement according to claim 1 wherein the mounting bracket(s) have web portions having an inclined surface extending from the central portion to the flange portions.

13. A mounting arrangement according to claim 1 comprising two mounting brackets, one having a central portion housing the ridge portions on the root portion and one having a central portion housing the ridge portions on the tip portion.

14. A vane assembly comprising:
a mounting arrangement according to claim 13;
a radially inner annular support; and
a radially outer annular support,
wherein the flange portions of the mounting bracket having a central portion housing the ridge portions on the root portion are affixed to the radially inner annular support and the flange portions of the mounting bracket having a central portion housing the ridge portions on the tip portion are affixed to the radially outer annular support.

15. A vane assembly according to claim 14 comprising a plurality of circumferentially-spaced aerofoil assemblies.

16. An mounting arrangement according to claim 1 incorporated into an axial compressor for a gas turbine engine.

17. A vane assembly according to claim 14 incorporated into an axial flow compressor for a gas turbine engine.

18. An mounting arrangement according to claim 1 incorporated into a gas turbine engine.

19. A vane assembly according to claim 14 incorporated into a gas turbine engine.
